(19) United States
(12) Patent Application Publication
(10) Pub. No.: US 2007/0058835 A1
(43) Pub. Date: Mar. 15, 2007

(54) Screen image authentication

(75) Inventors: Geert Jan Schrijen, Eindhoven (NL); Mark Thomas Johnson, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/576,313

(22) PCT Filed: Oct. 14, 2004
(86) PCT No.: PCT/IB04/52093

§ 371 Date: Apr. 18, 2006

(30) Foreign Application Priority Data
Oct. 21, 2003 (EP) 03103874.8

(51) Int. Cl. G06K 9/00

(52) U.S. Cl. 382/100

(57) ABSTRACT

A method of verifying the authenticity of an image (1) rendered on a display screen (10) involves using a graphical representation of an authentication code (2) associated with the image. The graphical representation of the authentication code is also rendered on the display screen, while optional guide marks (3) may also be displayed. Both the image (1) and the associated authentication code (2) are read using a scanner (20), preferably a handheld linear scanner. The scanner calculates an authentication code based upon the image and compares the calculated authentication code with the authentication code read from the display.

The present invention relates to a method of authenticating an image displayed on a screen. More in particular, the present invention relates to a method of verifying the authenticity of an image being rendered on a display screen.

Display screens are used for displaying various types of images. Some images may contain pure graphical information such as pictures, while other images may contain alphanumeric characters. In ATMs (Automatic Teller Machines) and computers, for example, the graphical screen image will typically be mixed and contain both pure graphical information such as symbols, and alphanumeric characters such as text and numbers.

Often display screens are used for carrying out transactions involving secret or confidential information. In ATMs, for example, secret access codes or PINs (Personal Identification Numbers) are used to authorize an electronic financial transaction. Similarly, computers may be used to carry out financial transactions via the Internet. In such instances, it is vital that the information rendered by the display screen is authentic, that is, is not tampered with. Cases of fraud involving “fake” ATMs have been reported, and it is well known that Internet traffic can be interfered with, possibly resulting in an unauthorized person gaining access to confidential or secret information.

The paper “The Untrusted Computer Problem and Camera-Based Authentication” by M. Burnside et al., MIT Technical Memo 450, March 2002, discloses a method of verifying the trustworthiness of a “public” computer, that is a computer available to the general public. In particular, the paper discloses a method of authenticating the image displayed on the screen of the computer. To this end, a camera monitors the display screen of the computer. The image on the screen contains security information, such as a MAC (Message Authentication Code), an encrypted serial number and an encrypted password. A camera-equipped security device checks the serial number, calculates a MAC on the basis of the information displayed on the screen and compares this calculated MAC with the MAC displayed on the screen. If all checks succeed the image is deemed to be authentic.

Although this Prior Art method provides an excellent degree of protection against tampering and security attacks, it suffers from the disadvantage that a camera must used. This is both cumbersome and relatively expensive. During an initial calibration phase, a mapping between the pixels (“picture elements”) of the display screen and the pixels of the camera has to be made. It will be clear that the need for such a calibration phase hampers the usefulness of this known method. In addition, the cost of a camera which necessarily involves a lens is relatively high, thus limiting large-scale consumer applications.

It is therefore an object of the present invention to overcome these and other problems of the Prior Art and to provide a method of verifying the authenticity of an image being rendered on a display screen which is both easier and less expensive. Accordingly, the present invention provides a method of verifying the authenticity of an image being rendered on a display screen using a graphical representation of an authentication code associated with the image, said graphical representation also being rendered on the display screen, the method comprising the steps of:
producing an electronic representation of the image, and
deriving the authentication code from its graphical representation,
wherein both the step of producing an electronic representation of the image and the step of deriving the authentication code from its graphical representation involves the use of a scanner having an array of photosensitive elements, which array can be moved relative to the image.

By using a scanner, both for reading (that is, producing an electronic representation of and optionally processing) the image and for reading the authentication code, the use of a camera and its associated drawbacks is avoided. In particular, no calibration phase is necessary while in a typical embodiment lenses can be omitted. In addition, a scanner can be smaller and less expensive than a camera.

Preferably, the scanner is a hand-held scanner. In a preferred embodiment, the scanner is a hand-held, portable scanner which can easily be carried by the user. In particular credit-card size scanners are preferred. An example of such a scanner is disclosed in United States Patent U.S. Pat. No. 4,922,111 (Sanyo Electric).

Although various types of scanners can be used, including scanners providing two-dimensional scanning, it is preferred that the scanner is a linear scanner. That is, the scanner has a linear array of scanning elements (photo-sensitive elements). By moving the linear array of scanning elements in a direction which is substantially perpendicular to the array, a two-dimensional scan is obtained.

Advantageously, the step of producing an electronic representation of the image and the step of deriving the authentication code from its graphical representation may together involve a single scanning motion. That is, a single scan is made in which both the image and the (graphical representation of the) authentication code are scanned. It is noted that the authentication code and the associated image are typically displayed simultaneously, although the authentication code could also be displayed before or after the associated image.

Although preferably a single scanner is used to scan the image and the authentication code, embodiments can be envisaged in which separate scanners are used.

A user can scan the image and the associated authentication code as often as desired. It is preferred that the user performs such an authentication scan every time the screen information is updated, or at least every time important and/or confidential screen information is updated. To this end, the display screen may provide a scanning prompt after the image is changed. Such a scanning prompt may comprise a text on the screen (e.g. “scan now”), a separate off-screen indication light and/or a sound signal or spoken message.

The image displayed may contain various types of information. The image may comprise alphanumeric characters, such as letters and numbers, but the image may also, or alternatively, comprise symbols and/or pictures. It will be understood that the method of the present invention is particularly useful when the image comprises financial information, such as bank account numbers, bank balances, account access codes and similar information.

The authentication code may be distinguished from the image proper displayed on the screen by its particular graphical representation, for example a bar code or another symbolic representation. Alternatively, or additionally, the graphical representation of the authentication code may comprise guide marks for guiding the scanner. In this case the guiding of the scanner may involve both guiding the user when using a hand-held scanner and facilitating the process of deriving the authentication code from its graphical representation. Guide marks may also be provided for scanning the entire image. For example, a line surrounding a particular image may serve as a guide mark and indicate the part of the screen which is to be scanned. Of course, symbols such as dots and/or triangles may be used instead of, or in addition to a line.

When scanning the image and the authentication code, both are preferably converted into an electronic representation such as a bit map. Any recognition of image features and of the authentication code may be based upon such a bit map, that is, may be based upon the electronic representation of the image. In an advantageous embodiment, however, the step of producing an electronic representation of the image involves optical character recognition (“OCR”). In this embodiment, any alphanumeric and/or other characters displayed on the screen are recognized. It will be understood that OCR may also be used to recognize the authentication code if this code is represented by suitable characters.

The method of the present invention may advantageously further comprise the steps of:
calculating a further authentication code on the basis of the electronic representation of the image, and
comparing the derived authentication code and the calculated further authentication code.

In this way, the authenticity of the image can be verified by way of the authentication code.

The present invention further provides a scanning device for use in the method as defined above, the scanning device comprising:
means for producing an electronic representation of the image,
means for deriving the authentication code from its graphical representation,
means for calculating a further authentication code on the basis of the electronic representation of the image,
means for comparing the derived authentication code and the calculated further authentication code, and
means for outputting a result of the comparison,
wherein both the means for producing an electronic representation of the image and the means for deriving the authentication code from its graphical representation involve an array of photosensitive elements, which array can be moved relative to the image.

The present invention will further be explained below with reference to exemplary embodiments illustrated in the accompanying drawings, in which:

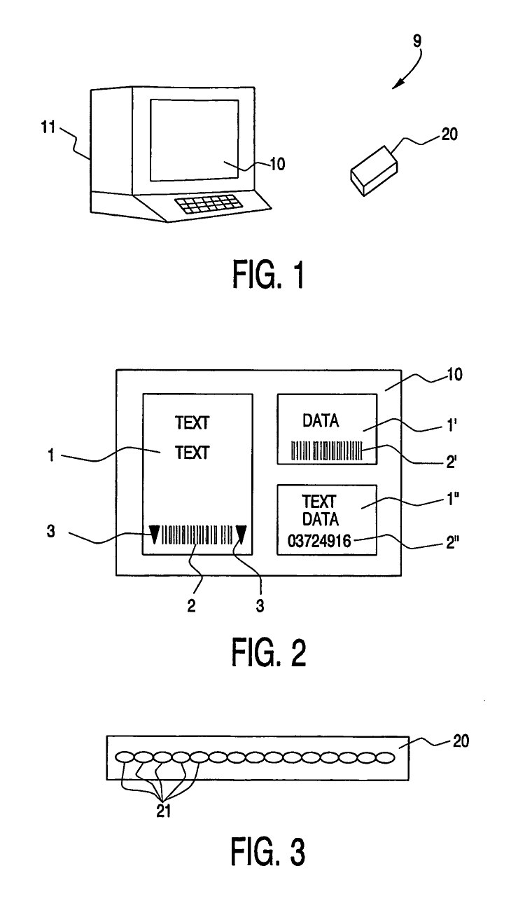

FIG. 1 schematically shows a system for image authentication according to the present invention.

FIG. 2 schematically shows screen images in accordance with the present invention.

FIG. 3 schematically shows, in side view, a scanner in accordance with the present invention.

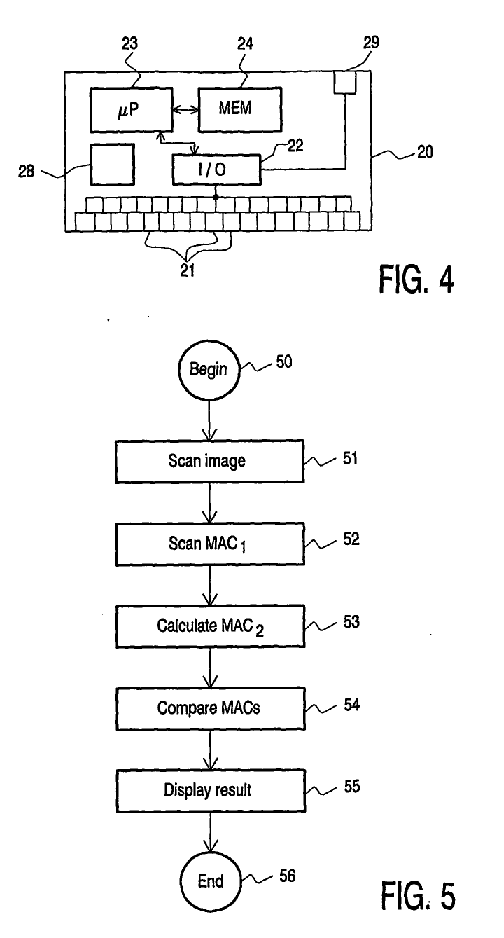

FIG. 4 schematically shows a schematic diagram of a scanner in accordance with the present invention.

FIG. 5 schematically shows a flow diagram of the method of the present invention.

The system 9 shown merely by way of non-limiting example in FIG. 1 comprises a display screen 10 and a scanner 20. The display screen 10 is, in the example shown, part of a terminal 11 which may be a commercially available personal computer, or an automatic teller machine (ATM) for carrying out financial transactions. The terminal 11 may be arranged for providing access to the Internet, a suitable LAN (Local Area Network) and/or another suitable network.

The display screen 10 may be an LCD (Liquid Crystal Display) screen, a CRT (Cathode Ray Tube), a plasma screen or any other suitable screen. The scanner 20 is, in the embodiment shown, a linear hand-held scanner which can be carried by the user. To scan any image displayed on the display screen 10, the user moves the scanner across the relevant section of the screen.

A possible lay-out of the screen 10 is shown in more detail in FIG. 2 where several images are displayed on the screen. Associated with each image 1, 1′, 1″ is a respective authentication code 2, 2′, 2″. In the example shown, the authentication code is part of each image, the image consisting of an image proper (text and/or data) and an authentication code. It is also possible to display the authentication code outside the associated image, and embodiments can be envisaged where the authentication code(s) is/are displayed in a dedicated section of the screen 10.

As shown in FIG. 2, the (graphical representation of the) authentication code may be a symbol code such as a bar code (2 and 2′), or an alphanumeric code (2″). It is also possible to display both a symbol code and an alphanumeric code. Optional guide marks 3 may be provided to guide the scanning of the authentication code 2, 2′, 2″. These guide marks 3 assist the user in directing a hand-held scanner when scanning the authentication code. In addition, the guide marks may facilitate the recognition of the authentication code during subsequent processing.

In addition to, or instead of the guide marks 3 shown in FIG. 2, other guide marks may be displayed, for example guide marks indicating the text and/or data to be scanned. Thus the guide marks could be constituted by a suitable image border and/or a set of symbols. Such symbols could suitably indicate which image or which part of the screen is to be scanned.

In a preferred embodiment, the scanner 20 is provided with optical character recognition (OCR) software and/or hardware. This allows the scanner to read and interpret both the text and/or data of the image and the alphanumeric authentication codes when the scanner is moved across the relevant sections of the screen 10.

In an alternative embodiment, however, the scanner is a bar code scanner provided with a key pad, the user being able to enter important data using the key pad and scanning the bar code representation of the authentication code of those key data. The user could, for instance, enter a bank balance or another confidential number in the key pad of the scanner and then scan the authentication code corresponding with the bank balance. The scanner would then check the authentication code and indicate whether the authentication codes matches the number which was keyed in.

The authentication code is preferably a so-called MAC (Message Authentication Code). A MAC is a number produced by using a so-called hash function which is a one-way function: it is relatively easy to derive the MAC from the input (here: the image data) using the hash function but it is virtually impossible to derive the input from the MAC. To provide additional security, the process of deriving a MAC typically involves the use of a cryptographic key. MACs, hash functions and cryptographic keys are well known to those skilled in the art and are described in more detail in the textbook “Applied Cryptography” by Bruce Schneier, second edition, John Wiley & Sons, 1996.

A side view of the scanner 20 is presented in FIG. 3. The scanner is shown to be provided with a row of photosensitive elements 21, for example photosensitive diodes which are well known in the art. By moving this one-dimensional array of photosensitive elements across the screen in a direction substantially perpendicular to the longitudinal direction of the array, a two-dimensional scan is obtained. It is, however, also possible to use a scanner having more than one row of photosensitive elements 21, for example two or four rows.

The exemplary scanner 20 schematically shown in FIG. 4 comprises a row of photosensitive elements 21, an input/output (I/O) circuit 22, a microprocessor (μP) 23, a memory 24, a battery 28 and an indicator 29. The photosensitive elements 21, which preferably are photosensitive diodes, are connected to the I/O circuit 22. The indicator 29, which is preferably constituted by a LED (Light Emitting Diode), is also connected to the I/O circuit 22. The microprocessor 23, which is connected to both the memory 24 and the I/O circuit 22, receives scanning signals from the I/O circuit 22 and, after suitable processing, returns an indication signal which controls the indicator 29. The indicator 29 may for instance light up in green if the authentication code is found to be correct and in red if it is not. A flashing indicator 29 may indicate an error, for instance a scanning error.

In the embodiment shown, the scanner 20 is a passive scanner which has no light source for illuminating the scanned object. As in the present invention the scanned object typically is a luminous display screen, a passive scanner is sufficient. However, embodiments can be envisaged in which the scanner is provided with a light source for illuminating the screen.

The scanner 20 is advantageously shaped and dimensioned so as to resemble a credit card or similar card, the photosensitive elements 21 preferably being accommodated in an edge of the card-shaped substrate constituting the scanner body. Thus a very compact and practical hand-held scanner is obtained.

The microprocessor 23 is arranged for carrying out suitable software programs stored in the memory 24. Such programs may include programs for optical character recognition, bar code recognition, producing an authentication code using an electronic representation of an image, and comparing authentication codes. Instead of, or in addition to the microprocessor and associated memory shown, a dedicated circuit such as an ASIC (Application Specific Integrated Circuit) may be used.

On the basis of the scanning signals produced by the photosensitive elements 21 and transmitted by the I/O circuit 22, the microprocessor 23 (or its equivalent) may produce a bit map of the scanned image, that is, a digital (electronic) representation of the image 1 and possibly also of the authentication code 2. The bit map may then be processed by the microprocessor 23 to produce an authentication code. Alternatively, optical character recognition is applied to the image and digital representations of the characters of the image are produced which then are used to produce an authentication code. In both cases, an electronic representation of the image is produced. Also, in both cases parts of the image may be selected to produce the authentication code: only particular areas, words and/or numbers may be used, thus reducing the computational load and the memory requirements.

As mentioned above, producing an authentication code typically involves a so-called hash function known per se, and typically also a cryptographic key. The particular procedure of producing an authentication code is not essential for the present invention.

The method steps of an advantageous embodiment of the present invention are illustrated in FIG. 5. After an initialization step 50, the image (1 in FIG. 2) is scanned in step 51 using a scanner. As a result of this scanning, the (microprocessor 23 of the) scanner 20 produces an electronic representation of the image, that is, a bit map and/or a character representation. In step 52 the authentication code (MAC) is scanned. Then the scanner 20 derives the numerical authentication code from its graphical representation. This first numerical MAC may be denoted MAC₁. It will be understood that steps 51 and 52 may be combined in a single step in which the entire image, including the MAC is scanned.

In step 53 the scanner calculates a further authentication code, denoted MAC₂, on the basis of the scanned image. As mentioned above, a selection step for selecting relevant parts of the scanned image may precede the calculation.

The authentication codes are compared in step 54: the scanner checks whether MAC₁=MAC₂. If this is true, the image corresponding with the MACs is deemed authentic and a positive indication is issued, for example the indicator 29 (FIG. 4) lighting up in green. If MAC₂ is not equal to MAC₁, a negative indication is issued, for example the indicator 29 lighting up in red. Step 56 concludes the procedure.

It is noted that in the above example it is assumed that all processing takes place in the scanner. Although this is the preferred arrangement, alternative embodiments are possible where the scanner is capable of communicating with a processing device, for example via a cable or a wireless connection using a suitable wireless protocol, such as Bluetooth®. In such an embodiment, the scanner could be less expensive and more compact.

The present invention is based upon the insight that for the verification of the authenticity of an image a scanner is much more practical than a camera The scanner can be hand-held, relatively inexpensive and does not require a calibration procedure. Using a scanner, consumers will be able to carry out secure transactions, even when the terminal they are using is not secure.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of verifying the authenticity of an image (1, 1′, 1″) being rendered on a display screen (10) using a graphical representation of an authentication code (2, 2′, 2″) associated with the image, said graphical representation also being rendered on the display screen, the method comprising the steps of:
producing an electronic representation of the image, and
deriving the authentication code from its graphical representation,
wherein both the step of producing an electronic representation of the image and the step of deriving the authentication code from its graphical representation involve the use of a scanner (20) having an array of photosensitive elements (21), which array can be moved relative to the image.

2. The method according to claim 1, wherein the scanner (20) is a hand-held scanner.

3. The method according to claim 1, wherein the scanner (20) is a linear scanner.

4. The method according to claim 1, wherein the step of producing an electronic representation of the image and the step of deriving the authentication code from its graphical representation together involve a single scanning motion.

5. The method according to claim 1, wherein the display screen (10) provides a scanning prompt after the image is changed.

6. The method according to claim 1, wherein the image (1, 1′, 1″) comprises alphanumeric characters.

7. The method according to claim 6, wherein the image (1, 1′, 1″) comprises financial information.

8. The method according to claim 1, wherein the graphical representation of the authentication code (2, 2′, 2″) comprises guide marks (3) for guiding the scanner.

9. The method according to claim 1, wherein the step of producing an electronic representation of the image involves optical character recognition.

10. The method according to claim 1, further comprising the steps of:
calculating a further authentication code on the basis of the electronic representation of the image, and
comparing the derived authentication code and the calculated further authentication code.

11. A scanning device (20) for use in the method according to claim 1, the scanning device comprising:
means (21, 22, 23) for producing an electronic representation of the image,
means (23, 24) for deriving the authentication code from its graphical representation,
means (23, 24) for calculating a further authentication code on the basis of the electronic representation of the image,
means (23, 24) for comparing the derived authentication code and the calculated further authentication code, and
means (29) for outputting a result of the comparison,
wherein both the means for producing an electronic representation of the image and the means for deriving the authentication code from its graphical representation involve an array of photosensitive elements (21), which array can be moved relative to the image.

12. The scanning device according to claim 11, wherein the array of scanning elements (21) is a linear array.

13. The scanning device according to claim 11, wherein the photosensitive elements (21) are photosensitive diodes.

14. The scanning device according to claim 11, which is a hand-held device.

15. The scanning device according to claim 11, wherein the photosensitive elements (21) are accommodated in an edge of a card-shaped substrate.

16. A system (9) for securely displaying images, the system comprising a display device (11) for rendering an image (1, 1′, 1″) and a graphical representation of an associated authentication code (2, 2′, 2″), and a scanning device (20) according to claim 11 for producing an electronic representation of the image and deriving the authentication code from its graphical representation.
